(19) United States
(12) Patent Application Publication
(10) Pub. No.: US 2022/0250887 A1
(43) Pub. Date: Aug. 11, 2022

(54) SYSTEM FOR GUIDING AN INDUSTRIAL TRUCK

(71) Applicant: Jungheinrich Aktiengesellschaft, Hamburg (DE)

(72) Inventor: Robert HÄMMERL, Angerberg (AT)

(21) Appl. No.: 17/668,000

(22) Filed: Feb. 9, 2022

(30) Foreign Application Priority Data
Feb. 10, 2021 (DE) 10 2021 103 052.8

(51) Int. Cl. B66F 9/075; G05D 1/02

(52) U.S. Cl. CPC B66F 9/0755; B66F 9/07581; G05D 2201/0216; G05D 1/024; G05D 1/0212

(57) ABSTRACT

A system for guiding an industrial truck in a high-bay store comprising a plurality of bay posts, the system including a sensor unit configured to record vehicle position data that represent a relative or absolute current position of the truck. The system includes a bay post determination unit configured to determine at least one bay post that is to be expected in an event of further travel of the truck and bay post position data that represent a relative or absolute position of the at least one bay post. The system includes a computing unit configured to communicate with the sensor unit and with the bay post determination unit and to calculate a desired travel route of the truck based on the vehicle position data and the bay post position data. The system includes a control unit configured to guide the truck based on the desired travel route.

The present invention relates to a system for guiding an industrial truck in a high-bay store, an industrial truck comprising a system of this kind, and a method for guiding an industrial truck by means of a system of this kind.

In order that industrial trucks, in particular high-bay or narrow-aisle stackers, can work in a reliable and safe manner in bay aisles having a minimum aisle width, guide systems are essential. The guide systems furthermore allow for autonomous driving of the industrial trucks in a high-bay store, as well as high travel and lifting speeds. For this purpose, in practice in particular rail guidance systems and inductive guidance systems are currently frequently used.

In the case of rail guidance systems, the industrial truck is held in a track between the guide rails by means of lateral guide rollers and guide rails.

In contrast, in the case of inductive guidance systems, a guidewire through which an alternating current flows is laid in the center of a planned travel path, in the warehouse floor, at least two antennae being attached, in each case, to the front and rear of the corresponding industrial truck, in order to record a magnetic field of the guidewire, and thus to determine spacings between the relevant antenna and the guidewire. On the basis of the determined spacings, a control unit may generate a steer angle specification, in order to counteract or adjust deviations from the desired travel.

The guide systems described above have their disadvantages, however. For rail guidance, in all bay aisles guide rails must be attached along the planned travel path. In this case, the guide rails furthermore require a base or a lower bay surface, since on account of the guide rails goods cannot be stored directly on the floor. In contrast thereto, the inductive guidance system can be introduced into the travel path in a substantially simpler manner, storage of the load on the floor not being impeded thereby. However, significant installation outlay for the guidewire in each bay aisle is required.

In order to allow for autonomous or semi-autonomous driving, warehouse navigation systems also offer solutions for guiding industrial trucks in order to prevent collisions with objects in the vicinity.

An automated material handling system is known in each case from U.S. Pat. No. 8,965,561 B2 and U.S. Pat. No. 10,346,797 B2, sensors being attached to an industrial truck in order to record objects in the vicinity thereof, such that a collision-free progressive movement route of the industrial truck can be planned. It is problematic, in this case, that on the one hand the fixed bay structure, required for orientation of the industrial truck, may be hidden by stored, movable goods, and on the other hand orientation on the basis of the movable goods alone is not reasonable, since it could be the case that the goods are not stored neatly or that the goods are stored just on one side, in a bay aisle, and a storage area on the opposite side of the bay aisle is empty. There is furthermore the risk that the goods are taken out of the store again or restored, despite being stored away exactly, such that the goods contour to be recorded can change quickly over time.

An object of the present invention is that of providing an improved or alternative solution, compared with the prior art, for guiding an industrial truck, in particular a narrow aisle stacker, in order to allow for reduced installation outlay and nonetheless reliable guidance of the industrial truck in a high-bay store.

According to a first aspect of the invention, this object is achieved by a system for guiding an industrial truck in a high-bay store, the high-bay store comprising a plurality of bay posts, the system comprising: a sensor unit which is designed for recording vehicle position data which represent a relative or absolute current position of the industrial truck; a bay post determination unit which is designed to determine at least one bay post that is to be expected in the event of further travel of the industrial truck, as well as bay post position data which represent a relative or absolute position of the at least one bay post; a computing unit which is designed to communicate with the sensor unit and the bay post determination unit and to calculate a desired travel route of the industrial truck on the basis of the vehicle position data and the bay post position data; and a control unit which is designed to guide the industrial truck on the basis of the desired travel route.

Bay posts are fixed components that form bays, the positions of which generally do not change over time. A bay post may be a vertical beam, a horizontal beam, or a combination thereof. In order to determine at least one bay post that is to be expected in the event of further travel of the industrial truck, a navigation map can be pre-stored in the bay post determination unit or in an external system, which navigation map communicates with the bay post determination unit. The positions of fixed bay posts are preferably stored in the navigation map, such that the bay post determination unit can determine what bay posts the industrial truck is to expect during further travel, if the industrial truck moves onwards from a starting point to a planned end point, provided that the current position of the industrial truck is known.

The main concept of the invention consists in planning the desired travel route of the industrial truck using the invariable bay post positions. The bay post position data can be stored in a local or external data unit, such that the bay post determination unit can retrieve the bay post position data without having to record bay posts using sensors. Alternatively, bay posts can also be identified in each case by an RFID transponder for example, in which either only a unique identification number or both an identification number and the bay post position data of the relevant bay post are stored, such that, upon detection of the RFID transponder, the bay post determination unit can read out corresponding bay post position data directly from the transponder, or retrieve said data from an external system.

In order to improve the desired travel route or to prevent a possible collision with badly stored goods, the system preferably further comprises a contour recording unit which is designed to record contours of bays and the objects received in the bays, for example pallets.

The computing unit is preferably furthermore designed for communicating with the contour recording unit, and optionally for adjusting the desired travel route on the basis of the recorded contours. As a result, the industrial truck can be guided on an improved travel route, it being possible for example for a minimum spacing between the industrial truck and the stored pallets, at the side of a bay aisle, to be maintained.

In order to determine the at least one bay post and/or the bay post position data, the bay post determination unit is preferably designed for communicating with a local memory unit, a store management system, or a store navigation system, the bay post determination unit furthermore being designed to determine the at least one bay post and/or the bay post position data using the local memory unit, the store management system or the store navigation system, without having to record the at least one bay post using sensors. Bay modules having different identifying parameters with respect to the bay structure are preferably specified in the local memory unit, the store management system or the store navigation system, it being possible for the parameters to include for example the dimensions of the respective bay shelves, the positions of an identifying transponder in the entry region of a bay aisle or the spacing of the transponder from the first bay post of a bay aisle, the length of the bay aisle, the width of the bay aisle, etc., from which the absolute and/or the relative positions of the individual bay posts can be retrieved and/or determined, directly or indirectly.

In order to ascertain the desired travel route, the computing unit is preferably designed to calculate the desired travel route such that the desired travel route and the at least one bay post are at a predefined spacing from one another.

For travel in a bay aisle on both sides of which bays are installed, the bay post determination unit is preferably designed to determine a pair of bay posts, to be expected, on both sides of a bay aisle, as well as bay post position data of the bay posts of the pair, the desired travel route of the industrial truck being calculated on the basis of the vehicle position data and of the center point between the bay posts of the pair.

In order to record the vehicle position data of the industrial truck, in a preferred embodiment the sensor unit comprises a distance sensor which is designed to record a spacing between the industrial truck and a reference object, the distance sensor preferably being a time-of-flight sensor. The relative position of the industrial truck can be determined on the basis of the spacing, in combination with other information such as the orientation of the distance sensor.

In a further preferred embodiment, the sensor unit is designed to record odometry data of the industrial truck, from which the vehicle positions can be determined. Odometry data of a vehicle include position and orientation data of the vehicle, which are ascertained by means of propulsion system thereof. In order to ascertain the odometry data of a vehicle, in general measurement variables from at least one wheel speed sensor in the chassis, a yaw rate sensor in an anti-lock braking system (ABS) for example, or electronic stability control (ESP), and a steering sensor for measuring a steering wheel angle, are used, it also being possible, in the case of track-guided vehicles, that the measurement variables from the wheel speed sensor alone may suffice.

Furthermore, the sensor unit may comprise an RFID reader, the RFID reader preferably being attached to the industrial truck and being designed for example for recording RFID transponders embedded in the ground, which transponders in each case represent a fixed position, such that the vehicle position data of the industrial truck can be determined on the basis thereof.

In order to prevent collisions with protruding pallets or other objects on the travel path, the system preferably furthermore comprises an anti-collision sensor which is designed to record objects in the vicinity thereof, the control unit furthermore being designed to brake the industrial truck, if applicable, or to deflect the industrial truck from the desired travel route, if an object is recorded.

Alternatively or in addition, however, pallets protruding in this way could, in some circumstances, also be encountered in such a way that no deflection from the desired travel route takes place, but rather that the industrial truck simply travels past at a reduced speed, and/or said pallets are marked in the discussed store management system for position correction.

The anti-collision sensor and the contour recording unit are preferably formed by a single sensor which is preferably a laser scanner. Laser scanners are electro-optical sensors which scan their surroundings by means of a quickly rotating laser measuring beam, the measurement being based on what is known as a time-of-flight method. A commercially available laser scanner is usually designed for scanning the surroundings in one plane, a pulsed laser beam being deflected in different directions, in the plane, by means of a rotating mirror. In a commercially available laser scanner, the scanning can take place in a sector of up to 270°. For reasons of safety, at least one laser scanner is already present on many industrial trucks. The laser scanner can be used both for anti-collision purposes and for contour recording, as a result of which additional installation outlay can be prevented.

According to a second aspect, the invention relates to an industrial truck comprising a system according to the invention, the industrial truck preferably being a narrow-aisle stacker. The system according to the first aspect of the invention preferably serves as an extension of the industrial truck, the advantages of the industrial truck following from the advantages of the system.

In order to plan a suitable travel contour, the industrial truck preferably comprises a geometric data unit which is designed to store geometric data of the industrial truck. The geometric data include inter alia the width and the length of the industrial truck, such that a spacing of the industrial truck from the stored goods or from other objects can be calculated correctly.

According to a third aspect, the invention relates to a method for guiding an industrial truck in a high-bay store by means of a system according to the invention, the system optionally being associated with an industrial truck according to the invention, said method comprising: recording vehicle position data of the industrial truck, which represent a relative or absolute current position of the industrial truck;

determining at least one bay post that is to be expected in the event of further travel of the industrial truck, as well as bay post position data which represent a relative or absolute position of the at least one bay post; calculating a desired travel route on the basis of the bay position data and the vehicle position data; guiding the industrial truck on the basis of the desired travel route.

In a preferred embodiment according to the third aspect of the invention, the method further comprises recording contours of bays and the objects received in the bays, the method preferably comprising adjustment of the desired travel route on the basis of the recorded contours. Alternatively or in addition, however, pallets protruding in this way could, in some circumstances, also be encountered in such a way that no deflection from the desired travel route takes place, but rather that the industrial truck simply travels past at a reduced speed, and/or said pallets are marked in the discussed store management system for position correction.

The bay post position data are preferably retrieved from a local memory unit, a store management system, or a store navigation system, without having to record the at least one bay post using sensors.

For travel in a bay aisle on both sides of which bays are installed, the method preferably further comprises determination of a pair of bay posts to be expected in the event of further travel of the industrial truck, as well as bay post position data of the bay posts of the pair, the desired travel route of the industrial truck preferably being calculated on the basis of the vehicle position data and of the center point between the bay posts of the pair.

In a further preferred embodiment according to the third aspect of the invention, the method further comprises recording a spacing of the industrial truck from a reference object.

In addition or alternatively, the method can further comprise recording odometry data of the industrial truck.

The method preferably further comprises recording an object in the vicinity, and braking the industrial truck, or deflecting the industrial truck from the desired travel route, in order to prevent a collision of the industrial truck with the object.

The advantages of the method according to the third aspect of the invention and of the embodiments thereof set out above follow in each case from the advantages of the system according to the invention as well as the corresponding embodiments thereof.

In order to allow for a transfer between an existing or other navigation system and the system according to the invention for guiding the industrial truck, the method preferably further comprises guiding the industrial truck by means of an existing or other navigation system, as far as a specified starting transfer point, from which the industrial truck is guided by means of the system according to the invention. The existing or other navigation system can be based on various navigation technologies, which can for example be an RFID-based, camera-based, laser scanner-based navigation system, or a combination thereof. The starting transfer point can also be implemented together with various solutions, as an example it being possible for an RFID transponder, which stores a specified identification number of a bay aisle for example, to be inserted into the floor of the entry region of the bay aisle, such that, when the industrial truck travels into the bay aisle, the RFID transponder is detected and thus the transfer from the navigation system to the system according to the invention is made possible.

A transfer in the exit region is preferably also carried out, in a manner analogous to the transfer in the entry region. For this purpose, the method preferably comprises guiding the industrial truck by means of the system according to the invention, as far as a specified end transfer point, from which the industrial truck is guided by means of an existing or other navigation system. The end transfer point can also be identified by means of an RFID transponder.

The invention will be explained in greater detail in the following, on the basis of a preferred embodiment and with reference to the accompanying drawings, in which:

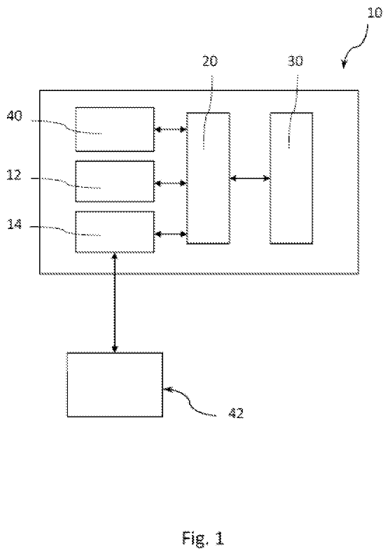

FIG. 1 is a schematic view of an embodiment of the system according to the invention for guiding an industrial truck;

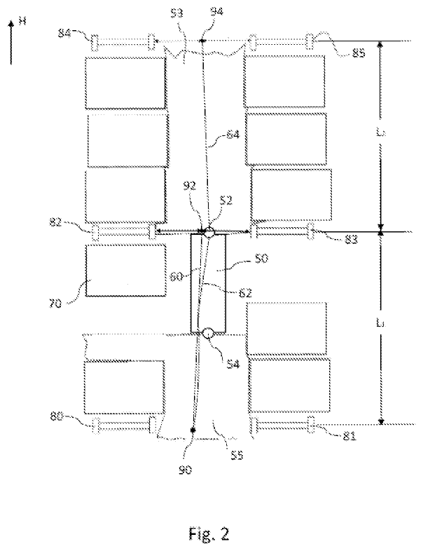

FIG. 2 is a schematic view of an industrial truck, guided by means of the system shown in FIG. 1, in a high-bay store;

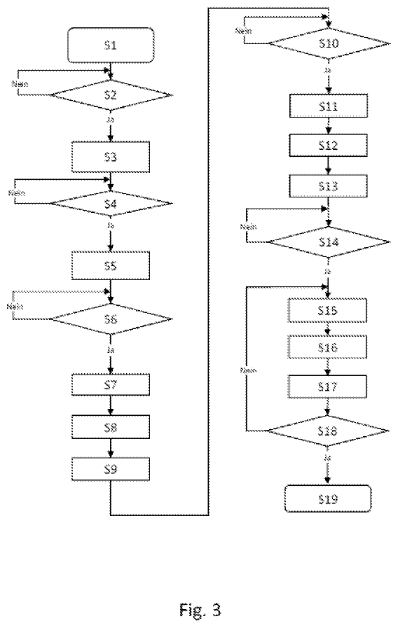

FIG. 3 is a flow diagram of a method for guiding the industrial truck shown in FIG. 2, in a high-bay store, by means of the system shown in FIG. 1.

In the embodiment shown schematically in FIG. 1, the system 10 for guiding an industrial truck comprises a sensor unit 12 which is designed for recording vehicle position data of the industrial truck, which represent a relative or absolute current position of the industrial truck. In the embodiment shown here, the sensor unit 12 can comprise an RFID reader which is preferably designed for reading RFID transponders embedded in the floor of a store, which transponders in each case identify a particular position in the store, such that it is possible to determine vehicle position data of the industrial truck at particular locations where the RFID transponders are provided. Other localization technologies such as image-based, distance measurement-based, WLAN-based or odometry data-based localization can of course replace or supplement the RFID-based solution, in order to record vehicle position data of the industrial truck.

The system 10 further comprises a bay post determination unit 14 which is designed to determine at least one bay post that is to be expected in the event of further travel of the industrial truck, as well as bay post position data which represent a relative or absolute position of the bay post. The bay post determination unit 14 can communicate with a store navigation system 42 shown in FIG. 1, in which system a navigation map can be pre-stored. The positions of fixed bay posts can be stored in the navigation map, such that the bay post determination unit 14 can determine what bay posts the industrial truck is to expect during further travel and where the bay posts are located, if the industrial truck moves onwards from a starting point to an end point, provided that the current position of the industrial truck is known.

The system 10 further comprises a computing unit 20 which is designed to communicate with the sensor unit 12 and the bay post determination unit 14 and to calculate a desired travel route of the industrial truck on the basis of the vehicle position data and the bay post position data. A control unit 30 is also provided in the system 10 and is designed to communicate with the computing unit 20 and to guide the industrial truck on the basis of the calculated desired travel route.

In order to improve the desired travel route or to prevent a possible collision with badly stored goods, the system 10 can further comprise a contour recording unit 40 which is designed to record contours of bays and the objects received in the bays, for example pallets. The computing unit 20 is preferably furthermore designed for communicating with the contour recording unit 40, and optionally for adjusting the desired travel route on the basis of the recorded contours, for indicating, by means of the control unit 30, travel of the industrial truck past said contour at a reduced speed, and/or for communicating contour data to the store management system 42. The contour recording unit 40 can comprise a laser scanner which is already present on several industrial trucks for anti-collision purposes, such that additional installation outlay can be avoided as a result.

FIG. 2 shows an industrial truck 50 that is guided in a bay aisle by means of the system 10 shown in FIG. 1 on both sides of which aisle bays are installed which comprise a plurality of fixed bay posts 80-85. At the moment shown in FIG. 2, the industrial truck 50 moves in the main travel direction H in the bay aisle, travel in the direction opposing the main travel direction H also being possible. A laser scanner 52 and 54 is provided in each case at the front and rear of the industrial truck, which scanners, as already discussed, can be used both for contour recording and for anti-collision purposes, a scanning region 53 of the laser scanner 52 and a scanning region 55 of the laser scanner 54 each being shown by peripheral dashed lines.

In the embodiment shown here, the computing unit 20 is designed to determine a pair of bay posts, to be expected, on both sides of the bay aisle, as well as bay post position data of the bay posts of the pair. Two partial stretches L1 and L2 in the bay aisle are shown in FIG. 2, which stretches are defined by three pairs of bay posts. In this case, the dashed line 60 represents a first desired travel route which the computing unit 14 has calculated using a prior waiting point 90 in the vicinity of the first pair of bay posts 80 and 81 and the center point 92 between the second pair of bay posts 82 and 83, to be expected, when the industrial truck 50 was at the point 90. RFID transponders can be embedded in the floor in the vicinity of the bay posts 80 and 81, such that vehicle position data of the industrial truck 50 could be recorded at the point 90.

As a result, the industrial truck 50 was guided, in the first partial stretch L1, on the basis of the first desired travel route 60. Since no further localizations of the industrial truck 50 took place during the travel in the first partial stretch L1, and the desired travel route 60 had to be adjusted for example on account of badly stored pallets 70, the actual travel route of the industrial truck (the solid line 62) deviated from the desired travel route 60.

When the industrial truck has reached the region in the vicinity of the second pair of bay posts 82 and 83, as shown in FIG. 2, it being possible to estimate for example using odometry data whether the industrial truck is in the region, which can alternatively also be achieved by means of sensors, the computing unit calculates a second desired travel route 64 on the basis of the current position of the industrial truck 50 and of the center point 94 between the third pair of bay posts 84 and 85, to also be expected, such that the industrial truck 50 is guided on the basis of the second desired travel route 64, during the second partial stretch L2.

The process set out above is repeated until the industrial truck 50 reaches the end of the bay aisle, it being necessary to note, in this case, that, on account of the large number of badly stored pallets the scenario shown in FIG. 2 is a case that is probably rarely relevant in practice, while the optimal desired travel route will be straight and will extend exactly between the bay posts in the case of a scenario having perfectly stored pallets.

FIG. 3 shows a flow diagram of a method for guiding the industrial truck shown in FIG. 2, by means of the system shown in FIG. 1. Firstly, in step S1 purposeful travel of the industrial truck in a bay aisle is started, following receipt of a transport request for example. Before a starting transfer point is reached, after which the industrial truck 50 is guided by means of the system 10 shown in FIG. 1, the industrial truck is preferably guided by an existing or other navigation system. For example, the guidance of the industrial truck can take place, up to the starting transfer point, only by contour recording of objects in the vicinity thereof, it being possible to check, in step S2, whether the targeted bay aisle, having an expected contour, can be identified. If so, in step S3 a lane is specified using the recorded pallet and/or bay contours, by which the industrial truck can be guided as far as the starting transfer point, it being possible for said lane to be determined for example on the basis of a current position of the industrial truck and of the center point of the pallets located on both sides of the bay aisle.

In the case of further travel, a check is made, in step S4, as to whether the starting transfer point has been reached, it being possible for the starting transfer point to be identified for example by means of an RFID transponder located in the entry region of the bay aisle. As soon as the starting transfer point has been achieved, a transfer takes place from the previous navigation system to the system according to the invention, in step S5 a desired travel route as far as the first pair of bay posts, to be expected, in the bay aisle being calculated. The industrial truck 50 is guided further on the basis of the first desired travel route.

As soon as it is identified, in step S6, that the industrial truck has reached a region in the vicinity of the first pair of bay posts, in step S7 the current position of the industrial truck is recorded, deviation of the current position of the center point between the bay posts of the first pair being possible. On the basis of the recorded current position of the industrial truck and the bay post position data of the second pair, to be expected, of bay posts, a second desired travel route is calculated in step S8, in the event of further travel contour recording being performed in step S9, and it optionally being possible for the second desired travel route to be adjusted.

In a similar manner a check is made, in step S10, as to whether the second pair of bay posts has been reached. If this is the case, in step S11 a current position of the industrial truck is recorded, a third desired travel route in turn being calculated in step S12, which route can optionally be adjusted, in step S13, on account of contour recording.

This process is repeated, it being possible for the nth desired travel route to be calculated and optionally adjusted, in steps S14-S17, until it is ascertained, in step S18, that the last pair of bay posts in the bay aisle has been reached. In the exit region an end transfer point is preferably installed, which can in turn be identified by an RFID transponder, it being possible for the end transfer point to be recorded in step S19, such that a transfer from the system according to the invention to another navigation system can take place.

1. A system for guiding an industrial truck in a high-bay store, wherein the high-bay store comprises a plurality of bay posts, the system comprising:
a sensor unit configured to record vehicle position data that represent a relative current position or an absolute current position of the industrial truck;
a bay post determination unit configured to determine (A) at least one bay post that is to be expected in an event of further travel of the industrial truck and (B) bay post position data that represent a relative position or an absolute position of the at least one bay post;
a computing unit configured to communicate with the sensor unit and with the bay post determination unit and to calculate a desired travel route of the industrial truck based on the vehicle position data and the bay post position data; and
a control unit configured to guide the industrial truck based on the desired travel route.

2. The system of claim 1, further comprising a contour recording unit configured to record contours of bays and the objects received in the bays.

3. The system of claim 2, wherein the computing unit is further configured to communicate with the contour recording unit.

4. The system of claim 1, wherein the bay post determination unit is configured to communicate with a local memory unit, a store management system, or a store navigation system, wherein the bay post determination unit is further configured to determine (a) the at least one bay post and/or (b) the bay post position data using the local memory unit, the store management system or the store navigation system without having to record the at least one bay post using sensors.

5. The system of claim 1, wherein the computing unit is configured to calculate the desired travel route such that the desired travel route and the at least one bay post are at a predefined spacing from one another.

6. The system of claim 1, wherein the bay post determination unit is configured to determine (1) a pair of bay posts to be expected, on both sides of a bay aisle and (2) bay post position data of the bay posts of the pair.

7. The system of claim 6, wherein the desired travel route of the industrial truck is calculated based on the vehicle position data and the center point between the bay posts of the pair.

8. The system of claim 1, wherein the sensor unit comprises a distance sensor configured to record a spacing between the industrial truck and a reference object.

9. The system of claim 8, wherein the distance sensor comprises a time-of-flight sensor.

10. The system of claim 1, wherein the sensor unit is configured to record odometry data of the industrial truck.

11. The system of claim 1, wherein the sensor unit comprises a radio frequency identifier (RFID) reader.

12. The system of claim 1, further comprising an anti-collision sensor configured to record objects in a vicinity of the anti-collision sensor, wherein the control unit is further configured to brake the industrial truck or to deflect the industrial truck from the desired travel route if an object is recorded, to prevent a collision of the industrial truck with the object.

13. The system of claim 12, further comprising a contour recording unit configured to record contours of bays and the objects received in the bays; and
wherein the anti-collision sensor and the contour recording unit comprise a single sensor.

14. The system of claim 13, wherein the single sensor comprises a laser scanner.

15. An industrial truck comprising a system for guiding the industrial truck in a high-bay store, wherein the high-bay store comprises a plurality of bay posts, the system comprising:
a sensor unit configured to record vehicle position data that represent a relative current position or an absolute current position of the industrial truck;
a bay post determination unit configured to determine (A) at least one bay post that is to be expected in an event of further travel of the industrial truck and (B) bay post position data that represent a relative position or an absolute position of the at least one bay post;
a computing unit configured to communicate with the sensor unit and with the bay post determination unit and to calculate a desired travel route of the industrial truck based on the vehicle position data and the bay post position data; and
a control unit configured to guide the industrial truck based on the desired travel route.

16. The industrial truck of claim 15, further comprising a geometric data unit configured to store geometric data of the industrial truck.

17. The industrial truck of claim 15, wherein the industrial truck is a narrow aisle stacker.

18. A method for guiding an industrial truck in a high-bay store, comprising:
recording vehicle position data of an industrial truck, the vehicle position data representing a relative current position or an absolute current position of the industrial truck;
determining (A) at least one bay post that is to be expected in an event of further travel of the industrial truck and (B) bay post position data that represent a relative position or an absolute position of the at least one bay post;
calculating a desired travel route based on the bay position data and the vehicle position data; and
guiding the industrial truck based on the desired travel route.

19. The method of claim 18, further comprising: recording contours of bays and the objects received in the bays.

20. The method of claim 19, further comprising: adjusting the desired travel route based on the recorded contours.

21. The method of claim 18, wherein one or more of the at least one bay post or the bay post position data of the at least one bay post is determined by means of a local memory unit, a store management system, or a store navigation system without having to record the at least one bay post using sensors.

22. The method of claim 18, further comprising:
determining (C) a pair of bay posts to be expected in an event of further travel of the industrial truck and (D) bay post position data of the bay posts of the pair.

23. The method of claim 22, wherein the desired travel route of the industrial truck is calculated based on the vehicle position data and the center point between the bay posts of the pair.

24. The method of claim 18, further comprising: recording a spacing of the industrial truck from a reference object.

25. The method of claim 18, further comprising: recording odometry data of the industrial truck.

26. The method of claim 18, further comprising:
recording an object in a vicinity;
braking the industrial truck or deflecting the industrial truck from the desired travel route to prevent a collision of the industrial truck with the object.

27. The method of claim 18, further comprising:
guiding the industrial truck by means of a navigation system, as far as a specified starting transfer point comprising the relative current position or an absolute current position of the industrial truck.

28. The method of claim 18, wherein guiding the industrial truck comprises guiding the industrial truck as far as a specified end transfer point, and further comprising:
guiding the industrial truck from the specified end point by means of a navigation system.

29. The system of claim 3, wherein the computing unit is further configured to adjust the desired travel route based on the recorded contours.
